(19) United States
(12) Patent Application Publication
(10) Pub. No.: US 2013/0254025 A1
(43) Pub. Date: Sep. 26, 2013

(54) ITEM RANKING MODELING FOR INTERNET MARKETING DISPLAY ADVERTISING

(71) Applicants: Yong Liu, San Jose, CA (US); Charles Bracher, Santa Cruz, CA (US); Tao Xiong, Cupertino, CA (US)

(72) Inventors: Yong Liu, San Jose, CA (US); Charles Bracher, Santa Cruz, CA (US); Tao Xiong, Cupertino, CA (US)

(73) Assignee: eBay Inc., San Jose, CA (US)

(21) Appl. No.: 13/425,938

(22) Filed: Mar. 21, 2012

(51) Int. Cl. G06Q 30/00; G06Q 30/02

(52) U.S. Cl. 705/14.53; 705/27.1; 705/26.7

(57) ABSTRACT

Item ranking modeling for internet marketing display advertising are described. The method of an example embodiment includes: identifying a plurality of items of secondary content for display to a particular user on an e-commerce site, the plurality of items of secondary content having associated secondary item information; obtaining user demographic and historical information associated with the particular user; generating a correlation between the secondary item information and the user demographic and historical information; generating scoring information based on the correlation between the secondary item information and the user demographic and historical information; and generating instructions to place one or more of the plurality of items of secondary content in slots of a graphical user interface (GUI) based on the correlation between the secondary item information and the user demographic and historical information and the related scoring information for a particular user.

### TECHNICAL FIELD

The present application relates generally to the technical field of data management and, in one specific example, to item ranking modeling for internet marketing display advertising.

### BACKGROUND

In online publication systems, advertisements or related content may be displayed in a particular area of the user interface to promote sales of related products/services. The resulting sales of related products/services can be increased if the displayed advertisements or related content are particularly suited to the user viewing the ads. For example, advertisements may be displayed that relate to content previously searched by a particular user. However, there may be millions of advertisements or related content from which to choose and millions of users to whom the advertisements or related content must be served. It is important to efficiently and quickly determine which advertisements or related content are served to a particular user. But, it is also important to efficiently and quickly determine the appropriate users to whom advertisements should be shown. It is not always cost-effective to show advertisements to certain groups of users. Moreover, it is not always cost-effective to show advertisements that merely relate to products and services.

### BRIEF DESCRIPTION OF THE DRAWINGS

Some embodiments are illustrated by way of example and not limitation in the figures of the accompanying drawings in which:

FIG. 1 is a diagrammatic representation of a portion of a user interface according to an example embodiment.

FIG. 2 is a diagrammatic representation of a portion of a user interface according to another example embodiment.

FIG. 3 is a block diagram of a placement system according to an example embodiment.

FIG. 4 is a flowchart of a process according to an example embodiment.

FIGS. 5A and 5B illustrate state diagrams correlating the displaying of secondary content with purchase actions in an example embodiment.

FIG. 6 is a flowchart of a process according to an example embodiment.

FIG. 7 illustrates the user/secondary content item correlation processing according to an example embodiment.

FIG. 8 is a flowchart of a process according to an example embodiment.

FIG. 9 is a network diagram depicting a client-server system, within which one example embodiment may be deployed.

FIG. 10 is a diagrammatic representation of machine in the example form of a computer system within which a set of instructions, for causing the machine to perform any one or more of the methodologies discussed herein, may be executed.

### DETAILED DESCRIPTION

Example methods and systems providing item ranking modeling for internet marketing display advertising are described. In the following description, for purposes of explanation, numerous specific details are set forth in order to provide a thorough understanding of example embodiments. It will be evident, however, to one of ordinary skill in the art that the various embodiments may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication environment, the embodiments are given merely for clarity in disclosure. Thus, any type of electronic publication, electronic commerce, or electronic business system and method, including various system architectures, may employ various embodiments of the system and method described herein and is considered as being within a scope of example embodiments. Each of a variety of example embodiments is discussed in detail below.

In a publication system, a graphical user interface (GUI) may be divided into one or more portions for different types of content. For example, a GUI may include a portion for receiving an input from a user such as a form or a search query box. The GUI may also include one or more content fields. Some GUIs may include a primary content field that includes content of particular interest to the user, for example, an article, a description of an item for sale, a map, or the like. Other GUIs, such as a search results page or a landing page, may not have a primary content field. Regardless of whether a particular GUI has a primary content field, the GUI may comprise slots placed at designated positions within the GUI populated with secondary content such as advertisements (ads), recommended content, related content, or the like. A slot is a predefined area of a GUI at a predetermined position. For example, the size of a particular slot may be defined based on a percentage of the area displayed to a user or be set in pixels. The GUI may be partitioned to include slots using a technology such as frames in hypertext mark-up language (HTML), HTML Tables, Java Script, HTML, <div> tags, and the like.

It may be desirable to place certain secondary content based on a predicted revenue yield generated by a particular item of secondary content. The “revenue yield” of an item of secondary content displayed in a particular slot is defined as an anticipated revenue to be derived from the user's interaction with the item of secondary content when it is placed in the particular slot. Examples of interactions include the user following a link in the secondary content (e.g., redirects), sales resulting from merchandizing items described by the primary content (e.g., conversions). For example, in a magazine site, it may be desirable to place a popular article in a slot at a top of the GUI. In an online marketplace, it may be desirable to place popular accessories related to an item for sale near an option to purchase the item. In some instances, a revenue yield may be predicted for each available item of secondary content. The revenue yield may be used to calculate an improved way to populate the slots in an interface with the secondary content. In some instances, the population of the slots is “optimized” using a matrix of the revenue yields for each available item of secondary content. The selection of the best collection of secondary content for a particular user based on item ranking modeling is described in more detail below.

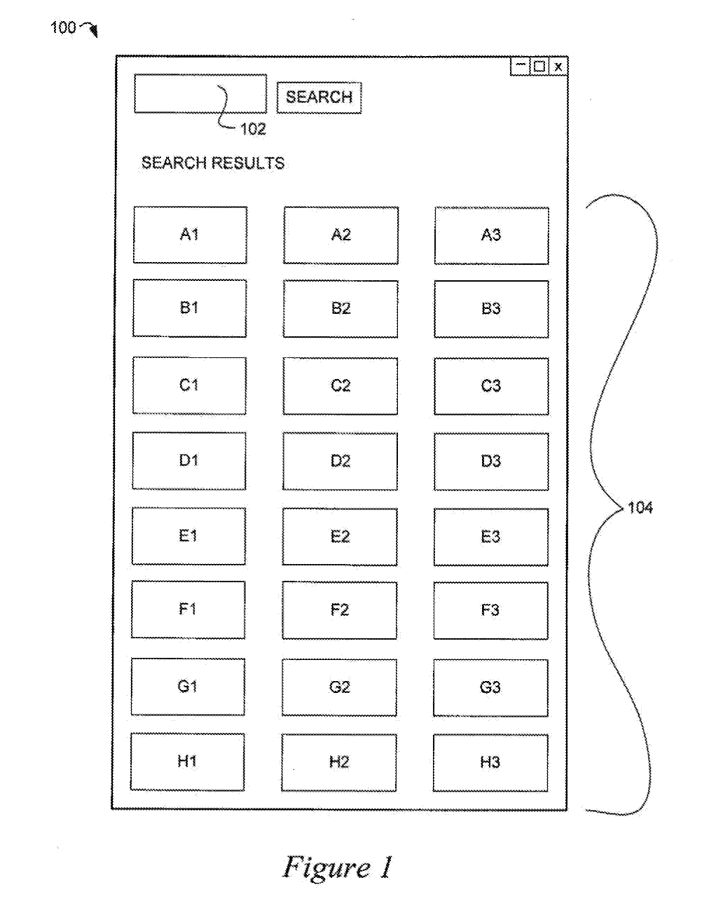

FIG. 1 is a diagrammatic representation of a portion of a GUI 100 according to an example embodiment. The GUI 100 includes a search box 102, and a set of slots 104. The twenty-four slots of the GUI 100 are respectively labeled A1-A3 to H1-H3. Each slot may be available or unavailable for placing secondary content and the GUI 100 may contain a mixture of available and unavailable slots. An unavailable slot is a slot that is populated with secondary content separately from the available slots which can be populated based on revenue yield. For example, a certain slot may be unavailable if it is designated as a “paid” slot that is to be populated with a paid advertisement. The unavailable slots may be independently populated according to a revenue yield. For example, the slots A1, A2, and A3 in the top row of the set of slots 104 may be sold to advertisers.

In an online marketplace, the search box 102 may be used to receive a query from a user for descriptions of items for sale. To illustrate, a user may enter, “music player.” The search results may include listings describing items for sale such as an IPOD music player, a ZUNE music player, and a WALK-MAN portable cassette player. To present the search results to the user, the listings (or links to the listings) may be used to populate at least a portion of the slots A1 to H3.

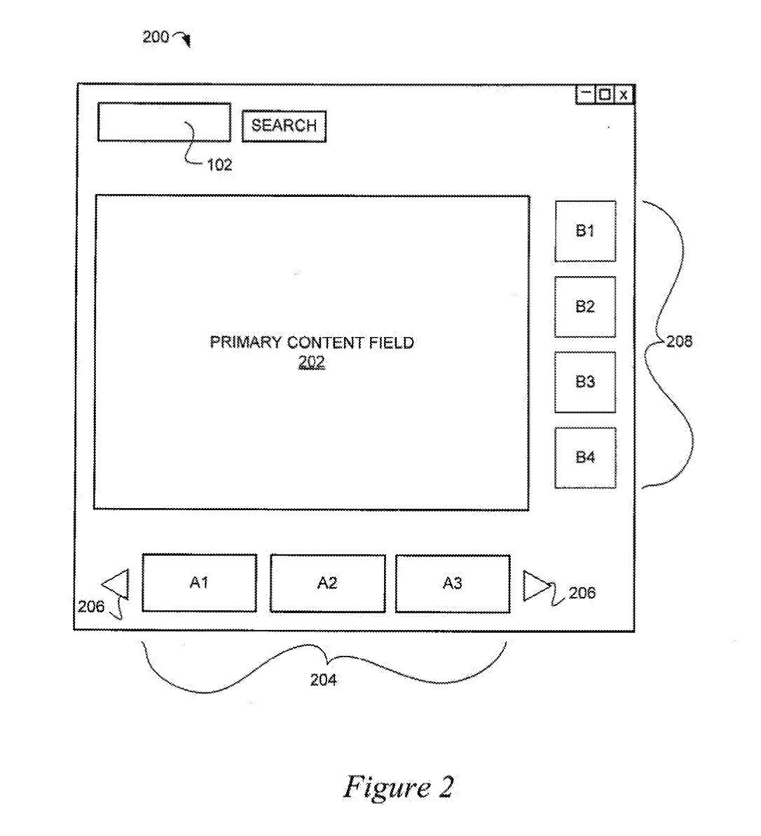

FIG. 2 is a diagrammatic representation of a portion of a GUI 200 according to another example embodiment. The GUI 200 may include a search box 102 and a primary content field 202. The GUI 200 also includes two sets of slots, set A 204 and set B 208. Set A 204 includes a row of slots, A1-A3 along a bottom of the GUI 200. Set A, as depicted, includes three slots that can be populated with secondary content. In some embodiments, a user may be able to cause the secondary content in the slots A1, A2 and A3 to scroll by selecting scroll buttons 206 on either side of the set A 204. GUI 200 further includes set B 208 that includes four slots, B1, B2, B3, and B4 positioned vertically along the right side of the GUI 200. In some instances, the secondary content to be displayed in GUI 200 may be independently determined for set A 204 and set B 208. For example, set A 204 may be designated for secondary content related to the primary content in the field 202 and set B 208 may be designated for paid content.

In an online marketplace, the primary content field 202 may include a product description or item listing that has been selected by the user from the GUI 100. Set A 204 may be populated with links to descriptions of related products (e.g., music player cases, earphones, batteries, and chargers). Set B 208 may be populated with links to descriptions of other items for sale based, for example, on user search history.

While example GUIs 100 and 200 are depicted in FIGS. 1 and 2, respectively, it is understood that alternative embodiments may comprise any combination of one or more primary content fields, secondary content fields, and user input fields (e.g., forms and search query boxes).

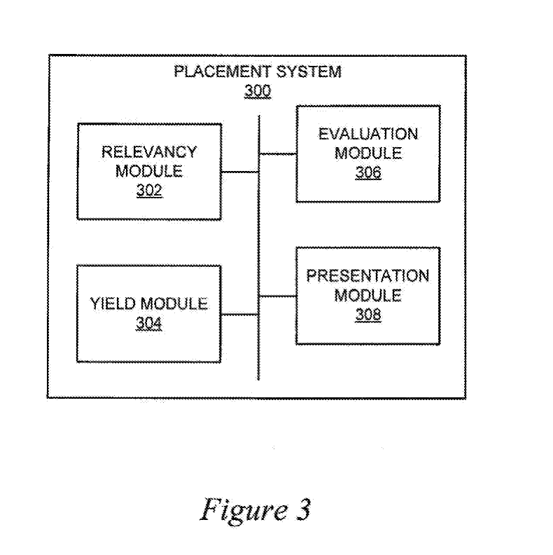

FIG. 3 is a block diagram of a placement system 300 according to an example embodiment. In one embodiment, the placement system 300 may be implemented by way of one or more software modules that include non-transitory instructions embodied on a computer-readable storage medium. In alternative embodiments, the placement system 300 may comprise hardware-based or processor-implemented modules. The placement system 300 is configured to place secondary content in slots within a GUI. In some embodiments, the placement system 300 places secondary content in available slots, but not in unavailable slots.

In response to a request for secondary content, a relevancy module 302 is configured to identify a set of secondary content to be used to populate the slots. The request for secondary content may be in the form of, for example, a search query received from a client device of a user, a server call for primary content, a selection received from a client device of a user to provide certain primary content, or the like. The request may include a request for a certain number of items of secondary content that, in turn, may or may not be included in a GUI.

In some instances, the request includes the number of items of secondary content to be placed and positions of the slots in the GUI. The request may include a GUI identifier that indicates a format of the GUI to be generated. The GUI identifier may be received from the system providing primary content, a search engine, or the like. Examples of GUI formats are depicted in FIGS. 1 and 2.

In some embodiments, particularly in online marketplace environments, the relevancy module 302 may include, or have access to, search capabilities to refine the available secondary content to those deemed most relevant to the user or to users who request to view a certain item of primary content. To illustrate, a user may submit a search query for primary content. The secondary content may be content that is determined to be related to the results of the primary content. Therefore, there is a determination by the relevancy module 302 of similar or corresponding categories of content that are related to the primary content. In some embodiments, the relationship of the secondary content to the primary content may be based on user preferences, past histories, user searches, user purchases, etc. But, the relevancy module 302 should also take into consideration the actions and behaviors of other users. For example, if a majority (or high percentage) of users who enter the same search terms for the primary content eventually purchase an accessory related to the primary content, that accessory (and an item of secondary content related thereto) can be identified by the relevancy module and weighted higher or more relevant by the relevancy module 302. In some instances, a selection or collection of secondary content may be selected from a much larger set of secondary content based on user search or purchase history and preferences, social network data about the user, using algorithms such as collaborative filtering and machine learning.

Upon identification of the selected set of secondary content, the yield module 304 is configured to calculate a predicted revenue value associated with the respective items of secondary content. In some instances, the number of items of secondary content may be limited to a pre-defined number. In some instances, the revenue yield is calculated as a time-series estimation or a moving average of a number of factors associated with the item of secondary content. The revenue yield may be a value between 0 and 1. The factors may include a relevancy weight used to determine the relevancy of the item of secondary content by the relevancy module 302, revenue generated by the website based on traffic to the secondary content (e.g., for paid advertisements), click-through probability, popularity (e.g., most e-mailed, most blogged, most watched), etc.

Specifically, in an online marketplace, the revenue yield may be calculated based on factors such as user search history; revenue generated by the online marketplace upon sale of a particular item; click-through history of the item description; if the user has previously purchased, bid on, or watched particular items; time remaining to purchase or bid on an item described in a listing; a number of items remaining for sale. The revenue yield may be calculated using a weighted average, a normalization factor, or the like. For example, a sample embodiment uses a formula such as:

revenue yield=0.20*(clickthough probability)+0.40*(price of item)+(0.10)*quality of item+(0.5)*relevancy of item

to calculate the revenue yield of a particular item of secondary content. The effect of placing an item of secondary content at a first slot versus at a second slot may be calculated using a second formula or be incorporated into a variable in the above equation, such as “clickthrough probability.”

In some embodiments, the revenue is calculated for each item of secondary content based on each particular slot. For example, using moving averages, it may be determined that secondary content A may have a revenue yield of 0.95 if placed in slot A1 but a revenue yield of 0.25 if placed in slot B1.

When each item of secondary content is associated with a corresponding revenue yield value, the evaluation module 306 calculates where each item of secondary content should be placed in the slots in the GUI to be presented to the user. In some instances, this may be performed separately for the content to be placed in available slots and in unavailable slots. The evaluation module 306 may first discard items of secondary content associated with a revenue yield that does not meet or exceed a predetermined threshold. The threshold may be determined empirically.

In various embodiments, the respective revenue yields are used to populate a matrix where each row is assigned a particular item of secondary content and each column is assigned to a particular slot. The values within the matrix represent an anticipated revenue yield if that particular item of secondary content is used to populate that particular slot.

In one embodiment, to calculate the matrix values, the revenue yields associated with the items of secondary content may be multiplied by a multiplier associated with that particular slot. The multiple may be a positive value between zero and one. For example, a left-most slot (being most likely to be selected by a user based on its location) may be associated with a multiplier of 1.0 while a right-most slot may be associated with a multiplier closer to zero, such as 0.1.

The evaluation module 306 may then perform a combinatorial optimization algorithm, such as the Hungarian algorithm, on the matrix and/or revenue yields calculated. Other optimization calculations may, additionally or alternatively, be structured such as dynamic programming problems.

Based on the results calculated by the evaluation module 306, a presentation module 308 generates a GUI having available slots populated with the secondary content. The presentation module 308 may generate HTML instructions to send to a user device for displaying the secondary content in the respective slots. It is noted, that depending upon the secondary content identified by the relevancy module 302 and the revenue yields calculated by the evaluation module 306, two separate users may not have access to the same secondary content even if they are viewing the same primary content.

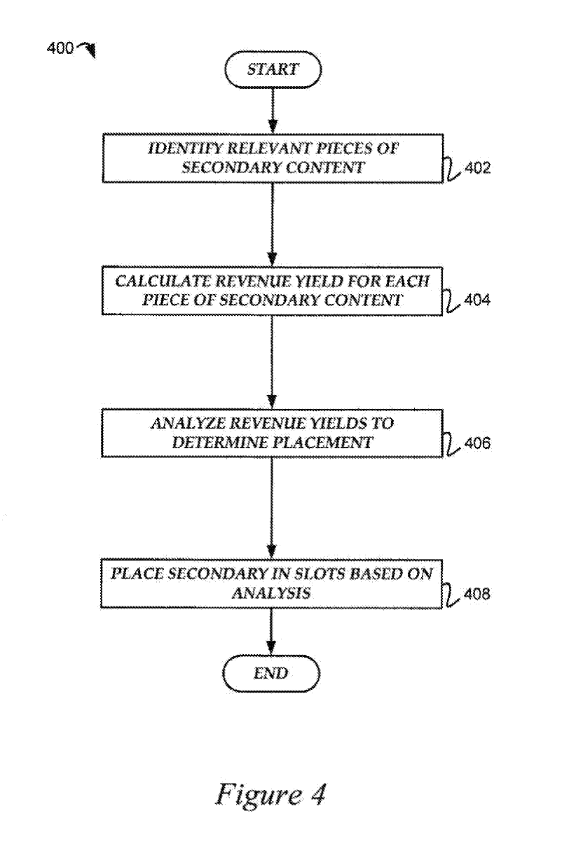

FIG. 4 is a flowchart of a process 400 to place listings according to an example embodiment. The process 400 may be performed by the placement system 300.

In an operation 402, the relevant items of secondary content are identified. The relevant items of secondary content may include, for example, advertisements, content related to primary content to be displayed to the user, related search results, listings describing items for sale, and user reviews or comments related to the primary content.

In an operation 404, the revenue yields for each item of secondary content is determined. In some instances, the revenue yield is calculated independent of an anticipated placement. In other instances, the revenue yield is determined as a function of its anticipated placement.

In an operation 406, the revenue yields are analyzed using a combinatorial optimization technique to determine how to collectively place the secondary content for a potential maximum yield.

In an operation 408, instructions for generating a GUI are generated. The instructions are generated by the presentation module 308 and transmitted to a client device of the requesting user. The instructions indicate placement of the respective items of secondary content in the available slots included in the GUI based on the analysis of operation 406.

### User Level Incremental Revenue and Conversion Prediction

For display advertising, especially for real time bidding, if we can predict how much incremental revenue a user is going to bring into a particular e-commerce site, we can decide how much we would like to pay for each impression shown to the user. Note that high revenue may not necessarily imply high incremental revenue, as some active users will visit a particular e-commerce site anyway, whether they see secondary content on the site or not, while some other inactive users do not visit the particular e-commerce site, even if they see a lot of secondary content. The past purchasing or transaction (conversion) history of a particular user can be used to determine a likelihood that the particular user will or will not be affected by viewing secondary-content. The past history of presenting secondary content to the user can also be used. The prediction model of an example embodiment provides support for solving this issue.

As mentioned above, for many e-commerce systems, some active users will visit a particular website to buy goods or services whether or not they are shown secondary content. Other inactive users will visit the particular website and not make a purchase no matter how many times they are shown secondary content. It is a waste of funds to show secondary content to a user who will not make a purchase (e.g., convert). It is also a waste of funds to show secondary content to a user who will make a purchase regardless. As described in more detail below, the user level incremental revenue and conversion prediction model of an example embodiment provides support to identify which users are likely to be affected by viewing secondary content and convert on the site, thereby bringing in incremental revenue.

The user level incremental revenue and conversion prediction model of an example embodiment provides a system and method to predict: 1) if a user is not originally likely to convert on the e-commerce site after viewing secondary content, how likely is it that the user can be affected into becoming a purchaser, and 2) if a user is originally likely to convert on the e-commerce site, how likely is it that the user can be affected into purchasing more than the user would have purchased without viewing the secondary content.

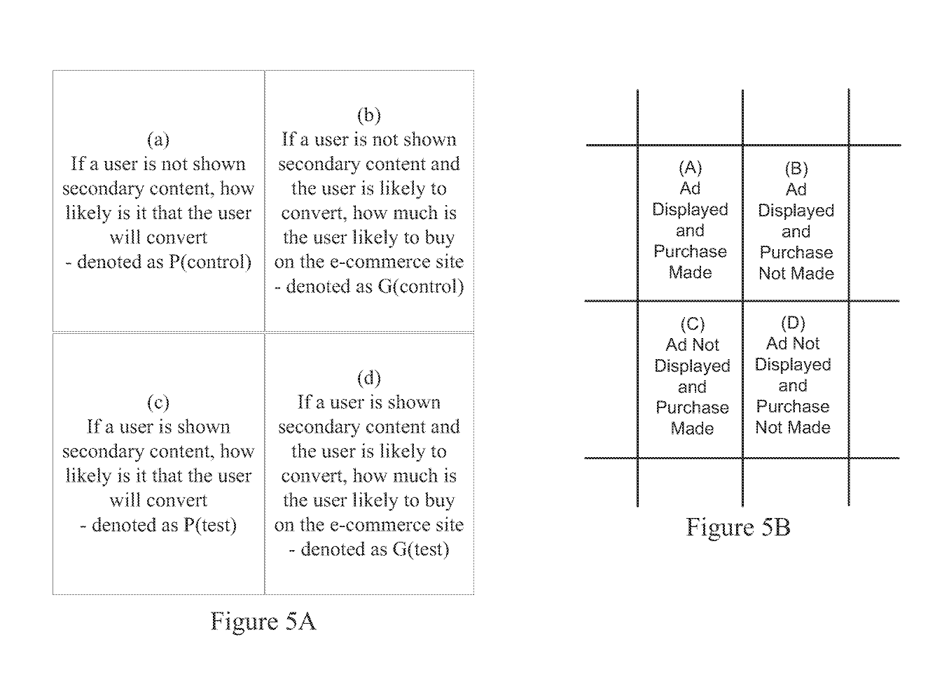

Referring now to FIG. 5A, four prediction models are provided in an example embodiment to predict any of the following conditions:
a. If a user is not shown secondary content, how likely is it that the user will convert—denoted as P(control).
b. If a user is not shown secondary content and the user is likely to convert, how much is the user likely to buy on the e-commerce site—denoted as G(control).
c. If a user is shown secondary content, how likely is it that the user will convert—denoted as P(test).
d. If a user is shown secondary content and the user is likely to convert, how much is the user likely to buy on the e-commerce site—denoted as G(test).

Having defined the conditions of interest and the mechanisms for metering the conditions, we can predict the incremental revenue as follows:

P(test)*G(test)−P(control)*G(control) up to the take rate.

Once the incremental revenue is determined for each user by use of the prediction models described above, we can decide how much we are willing to pay for each impression shown to the user. If the user's predicted incremental revenue is more that the cost of the impression to be shown to the user, we could pay a pre-determined amount, in the real time bidding, to maximize the incremental revenue for the e-commerce site.

FIG. 5B illustrates a state diagram correlating the displaying of secondary content with purchase actions in an example embodiment. As shown in FIG. 5B, one purpose of the embodiments described herein is to separate States A and D from States B and C. This can be achieved by a classification or prediction model as described above. Once we can separate States A and D from States B and C, we can use a classification model to rank the conversion probability for a particular user. In short, we can use two classification models; one is to differentiate the diagonal and non-diagonal conditions as shown in FIG. 5B. The other classification model is to differentiate the horizontal conditions as shown in FIG. 5B. The final score for each user will be the multiplication of the results of the two classification models. This final score can be used to adjust the amount of funds bid for impressions to be shown to the particular user. As a result, the user's predicted incremental revenue can be correlated to the secondary content shown to the user.

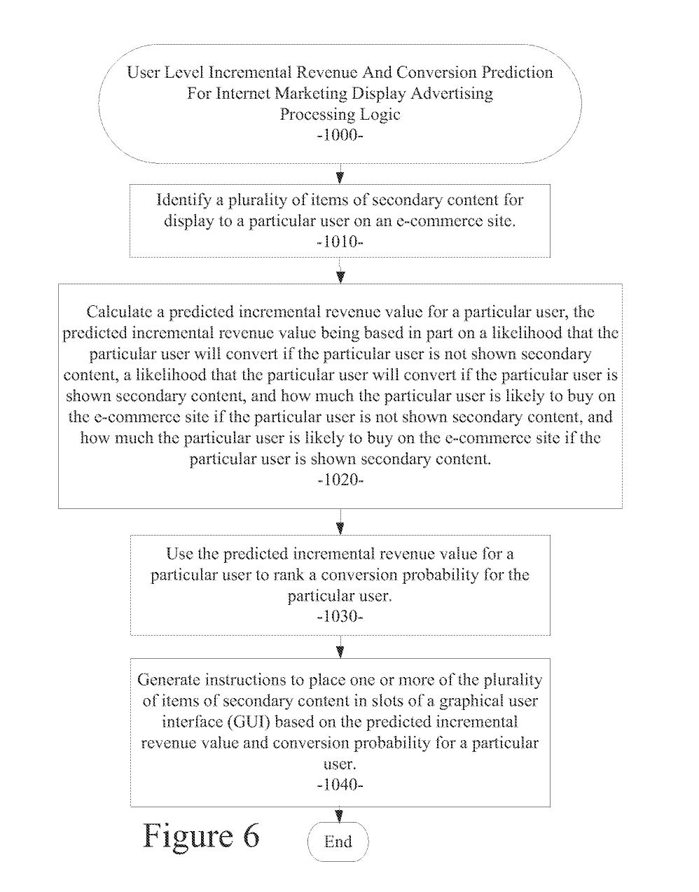

FIG. 6 is a processing flow diagram illustrating an example embodiment of a system and method for user level incremental revenue and conversion prediction for internet marketing display advertising as described herein. The method of an example embodiment includes: identifying a plurality of items of secondary content for display to a particular user on an e-commerce site (processing block 1010); calculating, using one or more processors, a predicted incremental revenue value for a particular user, the predicted incremental revenue value being based in part on a likelihood that the particular user will convert if the particular user is not shown secondary content, a likelihood that the particular user will convert if the particular user is shown secondary content, and how much the particular user is likely to buy on the e-commerce site if the particular user is not shown secondary content, and how much the particular user is likely to buy on the e-commerce site if the particular user is shown secondary content (processing block 1020); using the predicted incremental revenue value for a particular user to rank a conversion probability for the particular user (processing block 1030); and generating instructions to place one or more of the plurality of items of secondary content in slots of a graphical user interface (GUI) based on the predicted incremental revenue value and conversion probability for a particular user (processing block 1040).

### Item Ranking Modeling

Secondary content (e.g., advertisements, links to related articles, product/service listings of items for sale, etc.) can be shown to users of a host site or publisher site. When a user visits the host site or publisher site, the advertiser wants to show items to the user, which are likely to be of interest to the user. However, the host site or publisher site and the advertiser may have millions of listed items to show to the user. It becomes necessary to quickly identify the most relevant secondary content for the user.

Note that an item, which is interesting to user A, may not be interesting for user B. An effective process for ranking items of secondary content should be based on the user and the item concurrently. Hence, relevance ranking used in web searching can be used for ranking items of secondary content. However, instead of matching a query with a document as performed in the web search case, we match the user and the secondary content item in a ranking.

Thus, it becomes necessary to quickly rank all the secondary content for a given user. The idea is to transform the item ranking problem into a search ranking problem. Instead of matching a query to document, we match a user to an item of secondary content, and then apply machine learning ranking technology to rank the items of secondary content. This process is described in more detail below.

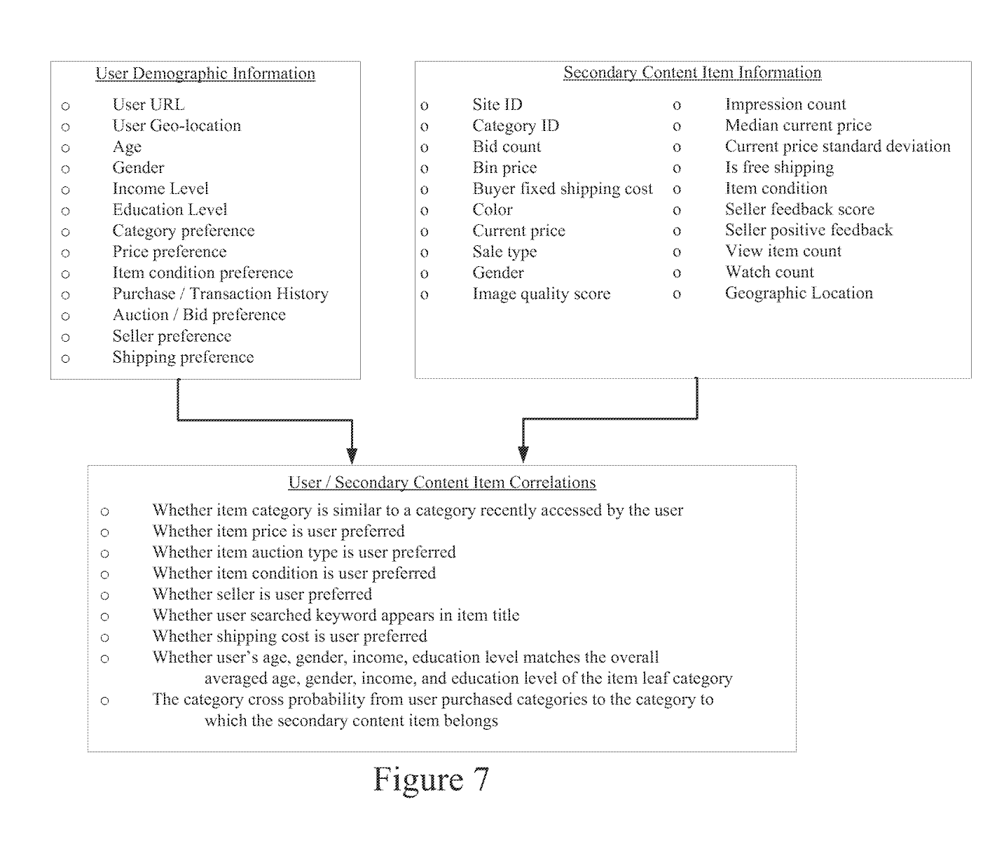

Referring now to FIG. 7, for each user, a variety of demographic and historical information is known or can be obtained, such demographic and historical information can include: user age, income level, gender, state or city, education level, historical bid/bin preference and search queries, last accessed product/service category, purchase or transaction history, and the like. Similarly, for each item of secondary content, a variety of information is known or can be obtained, such secondary content item information can include: category, price, title, description, sale type, and the like. Given the user demographic and historical information and the secondary content item information, we can determine, for example, if the secondary content item category matches the user's previously searched category or purchased category. Additionally, many other correlations can be determined between the user demographic and historical information and the secondary content item information. For example, a user/item correlation module, also denoted as the item ranking modeling module, can determine: a) if the secondary content item bid/bin sale type is a user preferred type, b) if the secondary content item price matches the user's price preference, etc. In general, the user/item correlation module can generate a correlation between the secondary item information and the user demographic and historical information by determining whether a particular element of secondary content information is within a pre-determined level of similarity to a corresponding element of user demographic and historical information. Based on the correlations determined by the user/item correlation module, we can build a machine learning item ranking model. Then, for each pair of user/item correlations (user, item), we can generate a corresponding score that corresponds to the presence and/or strength of the particular correlation. For any particular user, we can score a set of secondary content items and identify the secondary content items with the highest scores. The secondary content items with the highest scores can be selected and shown to the particular user. In this manner, the user can view secondary content items that are most likely of interest.

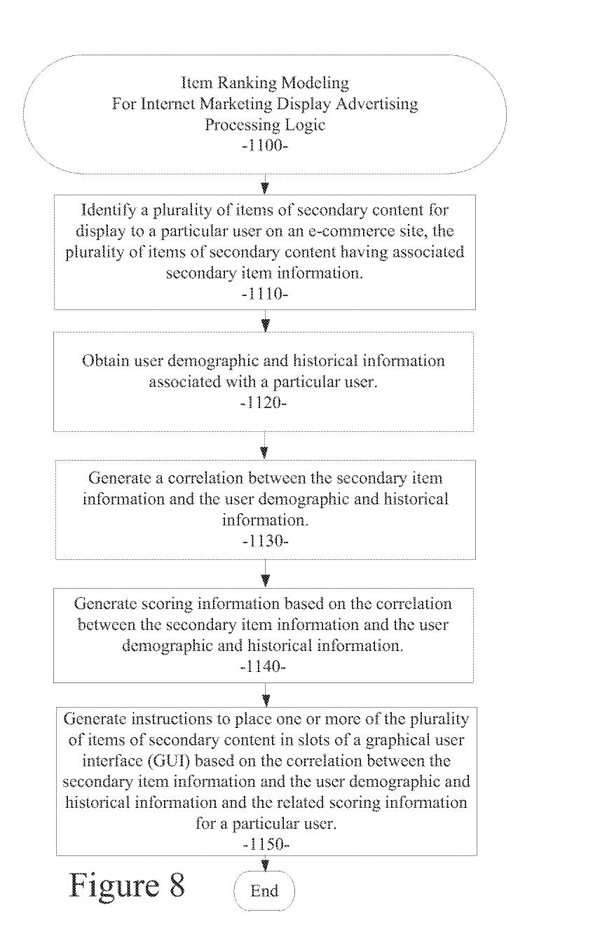

FIG. 8 is a processing flow diagram illustrating an example embodiment of a system and method for item ranking modeling for internet marketing display advertising as described herein. The method of an example embodiment includes: identifying a plurality of items of secondary content for display to a particular user on an e-commerce site, the plurality of items of secondary content having associated secondaryitem information (processing block 110); obtaining user demographic and historical information associated with the particular user (processing block 1120); generating a correlation between the secondary item information and the user demographic and historical information (processing block 1130); generating scoring information based on the correlation between the secondary item information and the user demographic and historical information (processing block 1140); and generating instructions to place one or more of the plurality of items of secondary content in slots of a graphical user interface (GUI) based on the correlation between the secondary item information and the user demographic and historical information and the related scoring information for a particular user (processing block 1150).

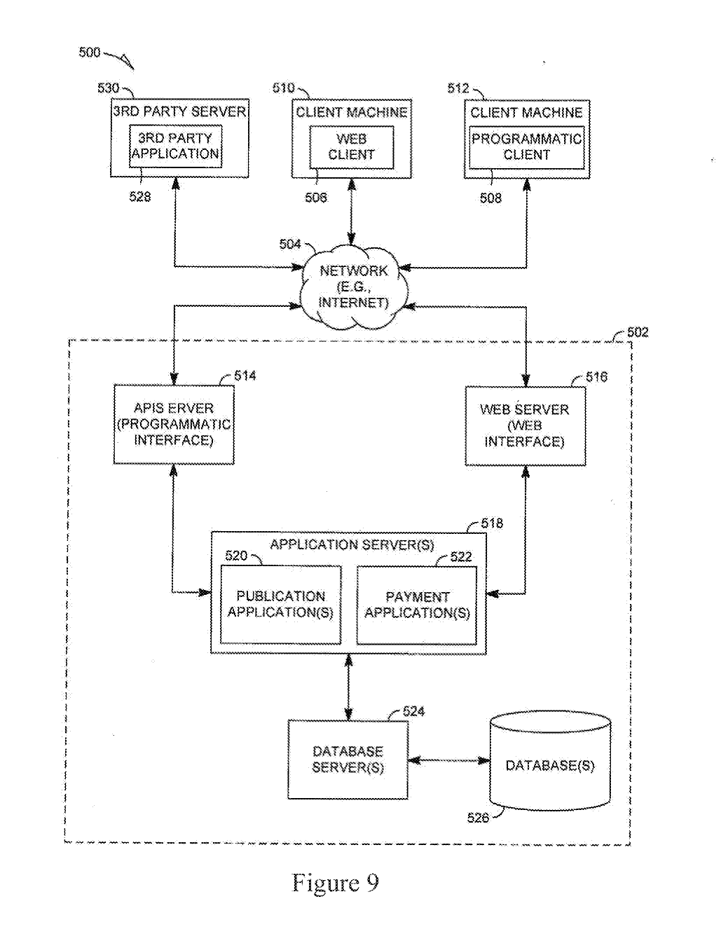

FIG. 9 is a network diagram depicting a client-server system 500, within which one example embodiment may be deployed. A networked system 502, in the example forms of a network-based marketplace or publication system, provides server-side functionality, via a network 504 (e.g., the Internet or Wide Area Network (WAN)) to one or more clients. FIG. 9 illustrates, for example, a web client 506 (e.g., a browser, such as the Internet Explorer browser developed by Microsoft Corporation of Redmond, Wash. State), and a programmatic client 508 executing on respective client machines 510 and 512. The client machine 510 may be a client device of a user submitting the primary content request. In response, a browser of the client machine 510 may generate the GUI shown in FIGS. 1 and 2 based on the instructions received from the presentation module 308.

An Application Program interface (API) server 514 and a web server 516 are coupled to, and provide programmatic and web interfaces respectively to, one or more application servers 518. The application servers 518 host one or more publication applications 520 and payment applications 522. The application servers 518 are, in turn, shown to be coupled to one or more databases servers 524 that facilitate access to one or more databases 526.

The publication applications 520 may provide a number of publication functions and services to users that access the networked system 502. In example embodiments, the publication applications 520 encompass the placement system 300. The payment applications 522 may likewise provide a number of payment services and functions to users. The payment applications 522 may allow users to accumulate value (e.g., in a commercial currency, such as the U.S. dollar, or a proprietary currency, such as “points”) in accounts, and then later to redeem the accumulated value for products (e.g., goods or services) that are made available via the publication applications 520. While the publication and payment applications 520 and 522 are shown in FIG. 9 to both form part of the networked system 502, it will be appreciated that, in alternative embodiments, the payment applications 522 may form part of a payment service that is separate and distinct from the networked system 502. The placement system 300 may be included in the publication applications 520.

Further, while the system 500 shown in FIG. 9 employs a client-server architecture, the various embodiments are of course not limited to such an architecture, and could equally well find application in a distributed, or peer-to-peer, architecture system, for example. The various publication and payment applications 520 and 522 could also be implemented as standalone software programs, which do not necessarily have networking capabilities.

The web client 506 accesses the various publication and payment applications 520 and 522 via the web interface supported by the web server 516. Similarly, the programmatic client 508 accesses the various services and functions provided by the publication and payment applications 520 and 522 via the programmatic interface provided by the API server 514. The programmatic client 508 may, for example, be a seller application (e.g., the TurboLister application developed by eBay Inc., of San Jose, Calif.) to enable sellers to author and manage listings on the networked system 502 in an off-line manner, and to perform batch-mode communications between the programmatic client 508 and the networked system 502.

FIG. 9 also illustrates a third party application 528, executing on a third party server machine 530, as having programmatic access to the networked system 502 via the programmatic interface provided by the API server 514. For example, the third party application 528 may, utilizing information retrieved from the networked system 502, support one or more features or functions on a website hosted by the third party. The third party website may, for example, provide one or more promotional, marketplace, or payment functions that are supported by the relevant applications of the networked system 502. In one embodiment, the third party server 520 may provide the paid advertisement that is used to populate the unavailable slots.

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

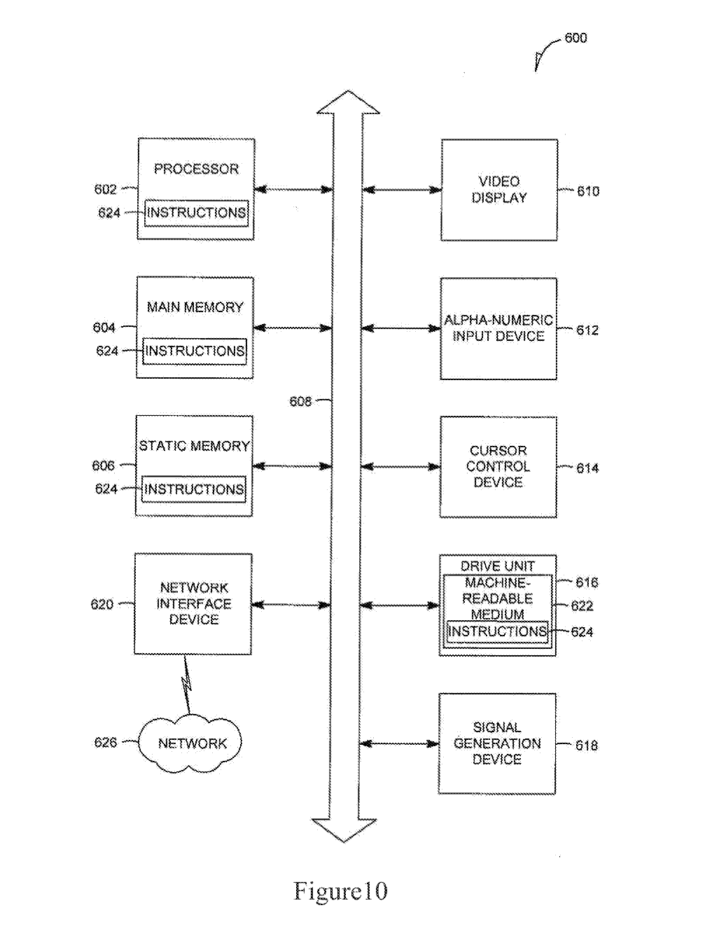

FIG. 10 shows a diagrammatic representation of machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620. Some embodiments may include a touchscreen (not shown).

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media. The software 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. In one embodiment, the machine-readable medium is a non-transitory machine-readable storage medium.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived there from, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

Thus, a method and system to provide item ranking modeling for internet marketing display advertising have been described. Although the various embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
identifying a plurality of items of secondary content for display to a particular user on an e-commerce site, the plurality of items of secondary content having associated secondary item information;
obtaining user demographic and historical information associated with the particular user;
generating a correlation between the secondary item information and the user demographic and historical information;
generating scoring information based on the correlation between the secondary item information and the user demographic and historical information; and
generating instructions to place one or more of the plurality of items of secondary content in slots of a graphical user interface (GUI) based on the correlation between the secondary item information and the user demographic and historical information and the related scoring information for a particular user.

2. The method of claim 1, wherein the secondary content comprises listings of items for sale.

3. The method of claim 1, wherein the secondary content comprises links to related articles.

4. The method of claim 1, wherein the secondary content comprises advertisements.

5. The method of claim 1, wherein the secondary item information can include: category, price, title, description, and sale type associated with the plurality of items of secondary content.

6. The method of claim 1, wherein the user demographic and historical information can include: user age, income level, gender, state or city, education level, historical bid/bin preference and search queries, last accessed product/service category, and purchase or transaction history associated with the particular user.

7. The method of claim 1, wherein generating a correlation between the secondary item information and the user demographic and historical information includes determining whether a particular element of secondary content information is within a pre-determined level of similarity to a corresponding element of user demographic and historical information.

8. The method of claim 1, wherein generating scoring information includes generating a score that corresponds to a presence and/or strength of a particular correlation between a particular element of secondary content information and a corresponding element of user demographic and historical information.

9. The method of claim 1 including selecting secondary content items with the highest scores and showing the selected secondary content items with the highest scores to the particular user.

10. The method of claim 1, wherein generating instructions to place one or more of the plurality of items of secondary content in slots of a graphical user interface (GUI) includes obtaining an item of secondary content from a server.

11. A system comprising:
a data processor;
a item ranking modeling module, executable by the data processor, configured to identify a plurality of items of secondary content for display to a particular user on an e-commerce site, the plurality of items of secondary content having associated secondary item information; to obtain user demographic and historical information associated with the particular user; to generate a correlation between the secondary item information and the user demographic and historical information; and to generate scoring information based on the correlation between the secondary item information and the user demographic and historical information; and
a presentation module configured to generate instructions to place one or more of the plurality of items of secondary content in slots of a graphical user interface (GUI) based on the correlation between the secondary item information and the user demographic and historical information and the related scoring information for a particular user.

12. The system of claim 11, wherein the secondary content comprises listings of items for sale.

13. The system of claim 11, wherein the secondary content comprises links to related articles.

14. The system of claim 11, wherein the secondary content comprises advertisements.

15. The system of claim 11, wherein the secondary item information can include: category, price, title, description, and sale type associated with the plurality of items of secondary content.

16. The system of claim 11, wherein the user demographic and historical information can include: user age, income level, gender, state or city, education level, historical bid/bin preference and search queries, last accessed product/service category, and purchase or transaction history associated with the particular user.

17. The system of claim 11, being further configured to determine whether a particular element of secondary content information is within a pre-determined level of similarity to a corresponding element of user demographic and historical information.

18. The system of claim 11, being further configured to generate a score that corresponds to a presence and/or strength of a particular correlation between a particular element of secondary content information and a corresponding element of user demographic and historical information.

19. The system of claim 11 being further configured to select secondary content items with the highest scores and show the selected secondary content items with the highest scores to the particular user.

20. The system of claim 11, wherein generating instructions to place one or more of the plurality of items of secondary content in slots of a graphical user interface (GUI) includes obtaining an item of secondary content from a server.

21. A non-transitory computer-readable storage medium having instructions embodied thereon, the instructions executable by a processor to cause a machine to:
identify a plurality of items of secondary content for display to a particular user on an e-commerce site, the plurality of items of secondary content having associated secondary item information;
obtain user demographic and historical information associated with the particular user;
generate a correlation between the secondary item information and the user demographic and historical information;
generate scoring information based on the correlation between the secondary item information and the user demographic and historical information; and
generate instructions to place one or more of the plurality of items of secondary content in slots of a graphical user interface (GUI) based on the correlation between the secondary item information and the user demographic and historical information and the related scoring information for a particular user.
